(19) United States
(12) Patent Application Publication
(10) Pub. No.: US 2010/0325699 A1
(43) Pub. Date: Dec. 23, 2010

(54) SYSTEM FOR PROVIDING AND MANAGING AN ONLINE COMMUNITY CONTAINING A WILL INFORMATION MANAGEMENT AND DISCLOSURE SYSTEM

(76) Inventors: Stefan KACZMAREK, Idstein (DE); Guido Polko, Sausalito, CA (US)

Correspondence Address: KF ROSS PC, 5683 RIVERDALE AVENUE, SUITE 203 BOX 900, BRONX, NY, 10471-0900, US

(21) Appl. No.: 12/486,071

(22) Filed: Jun. 17, 2009

(51) Int. Cl. G06F 15/16; H04L 9/32

(52) U.S. Cl. 726/4; 709/205

(57) ABSTRACT

A Community Website hosted on A Hosting Server maintained by a Hosting Entity and communicatively coupled to a network makes a Resource Center accessible to a plurality of members. The Resource Center has content generated by the members. A Content Management System can manage content on the Community Website so that a friendship tool allows the members to establish virtual friendships with one another “friend requests” and to add them to their virtual friendship network. The Content Management System contains a will information management and disclosure system for holding will information that it unseals in accordance with unsealing conditions registered in advance by a member and/or when the member has become unable to express his/her intentions and discloses to a predetermined recipient. The members enter as electronic information their deposit information in a rewritable manner via a depositor's terminal.

### FIELD OF THE INVENTION

The present invention relates to the field of online communities and, more particularly, a system and method for providing and managing an online community, and the program storage medium thereof, wherein a member of the online community can establish a virtual friendship network after creating an account with personal information, the system for providing and managing an online community further containing a will information management and disclosure system wherein a member of the online community deposits information, including will information, under predetermined conditions, and the deposit information is opened and disclosed when the member has become is unable to express his/her intentions due to death or for other reasons, and a virtual grave is generated which is accessible via a Community Website.

### BACKGROUND OF THE INVENTION

In modern society, a person is exposed to dangers due to unexpected accidents causing physical injury, or severe illness even at younger age. Therefore, many people prepare against possible accidents or illness by being insured and making a last will and testament. Additionally, there are an increasing number of people, not only elderly people, who want to keep information in advance in someone's custody and disclose the deposited information to an extend that is determined by specified conditions to persons designated in advance, using predetermined disclosure means, after their death, or when they have become unable to express their intentions due to illness, for example. Some people feel the need to secure the future of their family or friends, for example by regular allowances. Often, such regular allowances cannot be guaranteed over a longer time period after a person's death. Furthermore, some people would like to plan the time after their death, such as the organization of the funeral and the grave.

For this purpose, it has been widely practiced that the information stored in a rewritable manner in a data processing system is kept in custody and managed, and rewritten or output by an authorized person. It also has been practiced that a person operating a terminal retrieves the desired information stored at a remote location via the internet using the terminal. U.S. Pat. No. 6,246,991 B1 describes a will information management and disclosure system and method, and program storage medium thereof, wherein will information is kept in custody in a host processing system and unsealed under specific conditions to predetermined persons. Nevertheless, there is currently no possibility to deposit will information and manage the information within an online community, where an interaction between members of the online community is possible, the delivery of different kinds of information after the member's death is ensured, and a virtual grave which is accessible via the internet is generated.

### SUMMARY OF THE INVENTION

It is therefore an object of the present invention to create a system and method for providing and managing an online community, wherein a member of the online community can establish a virtual friendship network with a plurality of other members after creating an account containing personal information, the system for providing and managing an online community further containing a will information management and disclosure system wherein a member of the online community deposits information, including will information, under predetermined conditions, and the deposit information is opened and disclosed after the member's death or after other predetermined circumstances to specified persons (including the general public), and a virtual grave is automatically generated after the member's death, which is accessible via a Community Website.

Another objective of the present invention is to provide a program storage medium for realizing a system and method for providing and managing an online community in which a virtual friendship network can be established, including a will information management and disclosure system wherein a member of the online community deposits information, including will information, under predetermined conditions, and the deposit information is opened and disclosed after the member's death or after others predetermined circumstances, to specified persons (including the general public), and a virtual grave is automatically generated after the member's death, which is accessible via a Community Website.

The system for providing and managing an online community according to the present invention contains a Community Website hosted on at least one Hosting Server, the Hosting Server maintained by a Hosting Entity and communicatively coupled to a network; a Resource Center accessible to a plurality of members via the Community Website, the Resource Center having a plurality of content wherein at least some of the plurality of content is generated by at least one of the plurality of members; and a Content Management System having the ability to manage content on the Community Website. A friendship tool, which is accessible to the plurality of members via the Community Website, allows the plurality of members, after creating an account with their personal information, to establish at least one virtual friendship with others of the plurality of members via “friend request” and to establish a virtual friendship network. The Content Management System further contains a will information management system, which keeps the information deposited by a member of the online community in custody, and unseals the deposited information only under predetermined conditions. The deposited information is prepared by the member in a rewritable manner via a depositor's terminal and includes will information that can be disclosed to a predetermined person under unsealing conditions, registered in advance by the member and/or when the member has become unable to express his/her intentions.

The will information management and disclosure system comprises an electronic information depositing part for keeping in custody the entered electronic information in accordance with predetermined depositing conditions; an unsealing part for unsealing the deposit information using a predetermined unsealing electronic key, the unsealing part having first confirming means for confirming the establishment of predetermined unsealing conditions and second confirming means for confirming that the depositor has become unable to express his/her intentions; a recipient-specific delivery part for delivering the unsealed information for disclosure using predetermined means to persons designated in advance by the member and satisfying predetermined conditions; and a memorial generating part for generating a virtual grave, displaying part of the unsealed information to the plurality of members, the virtual grave being accessible via the Community Website.

The method for providing and managing an online community according to the present invention comprises a step of providing a Community Website accessible to a plurality of members via network; a step of hosting the Community Website on at least one Hosting Server; a step of providing a Resource Center having a plurality of content wherein at least some of the plurality of content was generated by at least one of the plurality of members; a step of entering as electronic information the deposit information prepared by a member of the online community in a rewritable manner with a view to depositing via a depositor's terminal; a step of storing the entered electronic information in accordance with predetermined depositing conditions; a step of unsealing the deposited information using a predetermined unsealing electronic key in response to confirming the occurrence of predetermined unsealing conditions, or in response to the member becoming unable to express his/her intentions; a step of delivering the deposit information for disclosure using predetermined means to a recipient designated in advance by the member and satisfying predetermined conditions; and a step of generating a virtual grave to display at least part of the deposit information, the virtual grave being accessible via the Community Website.

The present invention further provides a program storage medium that stores a program for implementing the aforementioned system and method for providing and managing an online community containing a will information management and is disclosure system.

### BRIEF DESCRIPTION OF THE DRAWINGS

FIG. 1 illustrates an exemplary embodiment of a system for providing and managing an online community.

FIG. 2 illustrates an exemplary embodiment of a will information management and disclosure system.

### DETAILED DESCRIPTION OF THE PREFERRED EMBODIMENTS

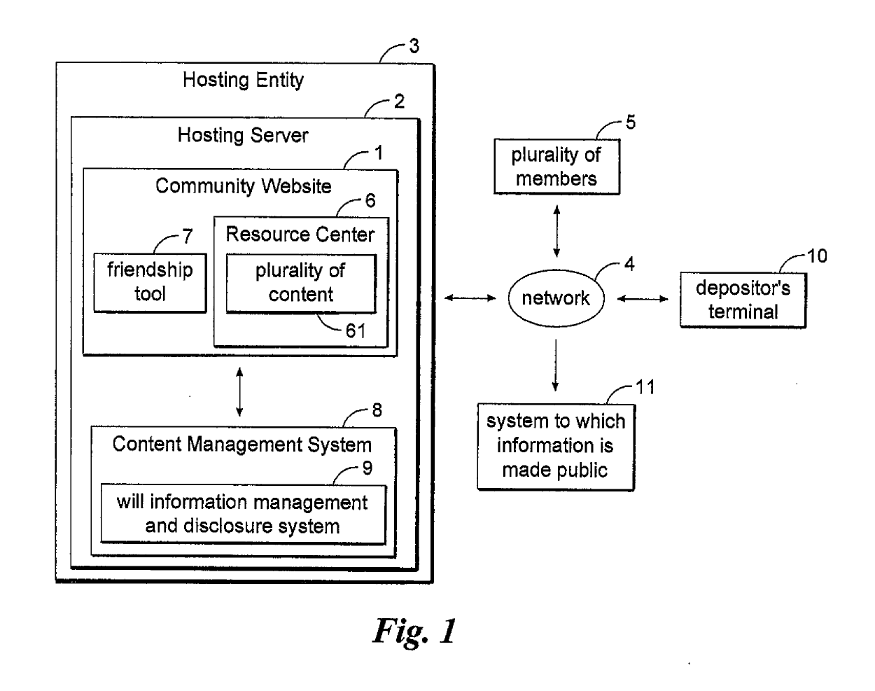

An example embodiment of a system for providing and managing an online community is illustrated in FIG. 1. This embodiment includes a Community Website 1 hosted on at least one Hosting Server 2, the at least one Hosting Server 2 maintained by a Hosting Entity 3 and communicatively coupled to a network 4; a Resource Center 6 accessible to a plurality of members 5 via the Community Website 1, the Resource Center 6 having a plurality of content 61, like deposit information, wherein at least some of the plurality of content is generated by at least one of the plurality of members; and a Content Management System 8 having the ability to manage content on the Community Website 1. The Community Website 1 also provides a friendship tool 7 allowing members to establish virtual friendships with other members, after creating an account with their personal information. The Content Management System 8 further contains a will information and disclosure system 9 for keeping in custody and unsealing deposited information under predetermined conditions and generating a virtual grave. The deposited information is prepared by the member in a rewritable manner via a depositor's terminal 10 and includes will information that can be disclosed to a predetermined person under unsealing conditions, registered in advance by the member and/or when the member has become unable to express his/her intentions.

Members may be required to register on the Community Website 1 before gaining access, by providing contact information and generating a username and a password and an individual profile. These profiles provide members with information about each other, and can contain the listed individual's name, address, phone number, website, digital identity, business information, and/or any other information the listed individual is willing to share with other members. Especially, it may be possible to display or deposit a plurality of photos from different ages of the member and videos, documenting special events or stages in the member's life. When the member is alive, he/she may have a basic account with limited functions. After the member's death, the member becomes a premium member of the “community of the dead”. During his/her life, each member can adjust his/her profile and present himself/herself as he/she wishes with documentations of his/her life, photos or videos. After the member's death more information can be released, so that the member is presented after his/her death, as he/she has prepared during the lifetime. Additionally, the online community has the advantage that special services to be fulfilled after the member's death can be booked in advance, such as a funeral, a grave, flowers, or even the invitations to the funeral. This enables the member to plan the life after his/her death in detail, and to make sure that the heirs do not have to deal with these problems after his/her death.

The Community Website 1 also provides a friendship tool 7, allowing members to form friendships with other members. The friendship tool 7 may be accessible to members via a friendship webpage. Alternatively, links to the friendship tool 7 may be made available on any other webpage on the Community Website 1. Members who form friendships may invite other members to join, possibly by communicating via a forum, or clicking on a link on a member's individual profile. A list of each member's friends may appear on the friendship webpage, perhaps along with links to the friend's individual profile. It may be possible to automatically import contacts from other business communities or friendship communities, or also from an e-mail account into the friendship tool 7. When the imported friends are no member of the online community, it may be feasible to automatically inform these friends about the existence of the online community and to allow those to gain access to the online community under special advantageous conditions. It may also be possible to link the online community to other known online community which may complement one another.

The Content Management System 8 contains a will information management and disclosure system 9. A member who wants to deposit information to the system enters information using the depositor's terminal 10. The deposit information thus entered is transmitted to the will information management and disclosure system 9 via the network 4, and stored for example in the memory 21 of the electronic information depositing part 20 or in the Resource Center 6. The deposit information is subjected to strict encryption when the depositor uploads it on the network 4 from the depositor's terminal 10, when the information is processed in the will information management and disclosure system 9, or when it is downloaded to the depositor's terminal 10 via the network 4. After predetermined conditions, the deposit information is unsealed and transferred to a system to which information is made public 11, the system being a public disclosure system for example.

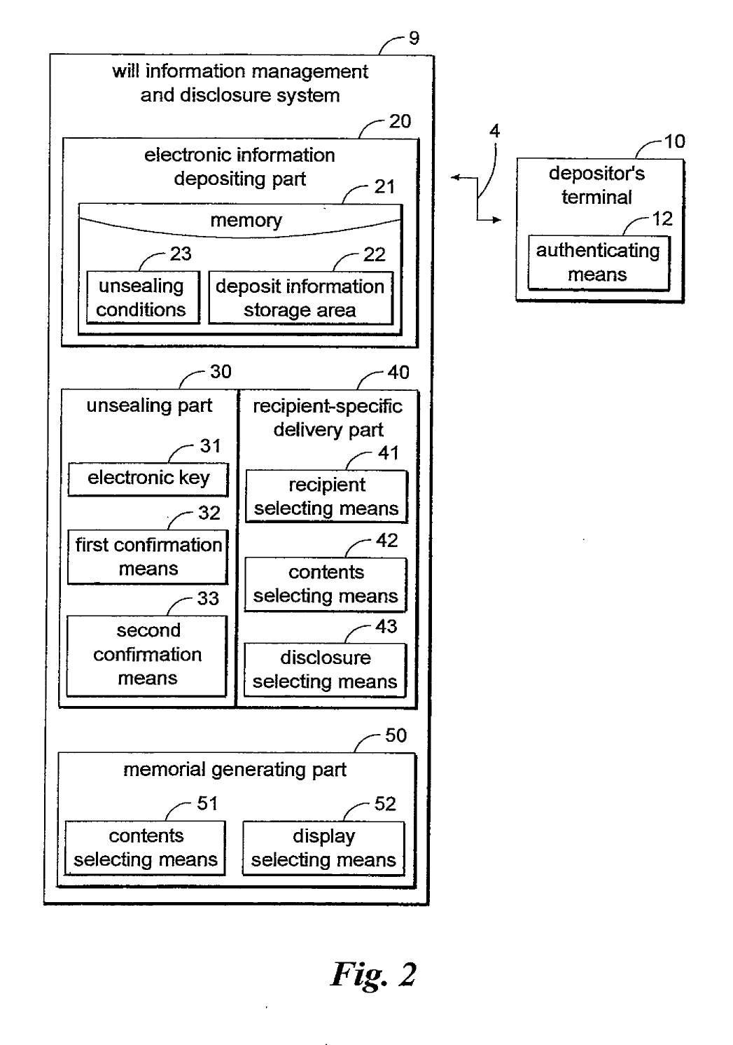

FIG. 2 shows an embodiment of the present will information management and disclosure system 9. In this embodiment, the depositor's terminal 10 comprises authenticating means 12 to confirm that an operator who deposits and/or manipulates deposit information using the depositor's terminal 10 is the authorized member. Authentication is carried out by authentication means 12 preparing information with a fingerprint, voiceprint, or using a combination of an insurance card or credit card and an autograph or password. Once registered in the system, the authenticating information stored in the system is used to compare with the information entered by an operator from the keyboard on the depositor's terminal 10. Before a member gains access to the will information management and disclosure system 9, the identity of the member has to be confirmed by sending a copy of an authentication certificate, such as a passport or driver's license.

When the member deposits information, the will information management and disclosure system 9 displays a deposit contract document on the display of the depositor's terminal. The member can then authenticate his/her identity, agree to the contract conditions, and enter the desired information.

The deposit information can exemplarily comprise the following information:
authentication of the member to confirm his/her identity,
the electronic key used to unseal the deposit information,
the name and date of birth of the member,
the contents of disclosure,
the names and addresses of recipients,
disclosure conditions specified for each recipient,
conditions for regular payments, and
properties of the virtual grave.

The deposit information is not limited to character information, but may also comprise video or audio records. The contents of deposit information may not only contain the member's last will and testament, but also autobiographic information and video or audio recordings which the member wants to disclose only after his/her death to certain persons or the general public.

The disclosure conditions contain the range of disclosure specified for each recipient, the time of disclosure which can be after the member's death or at another predetermined time point and the means of disclosure specified for each recipient, the means of disclosure being mail, courier service or electronic media.

Furthermore, conditions for regular payments can be determined in advance. These can ensure the payment of regular allowances to special friends or family members, or assure the payment of regular expenses, as for cemetery maintenance for example. In such a case, the member can specify, for how long the payment of which amount shall be guaranteed and deposit the total amount in advance. Alternatively, it is also possible to specify gifts or other allowances at predetermined time points as a birthday of a certain person or an anniversary of a specific event. This may ensure that the people that are designated by these allowances may look back to the member or specific events.

To ensure that designated persons know of the existence of a possible allowance, it may be advantageous to inform designated people in advance that they may expect an allowance from the member, so that the designated people can take care of all steps that are important to verify the member's death, so that the deposited information can be released.

The member can also determine in advance, which contents are to be displayed on the virtual grave after his/her death and which additional information he/she wishes to make public on the virtual grave, which is accessible via the Community Website.

The will information management and disclosure system 9 is at least subdivided into four parts and includes an electronic information depositing part 20, an unsealing part 30, a recipient-specific delivery part 40 and a memorial generating part 50.

The electronic information depositing part 20 carries out processing to manage and keep in custody the deposit information entered from the depositor's terminal. The information necessary for these functions is stored in a memory 21.

The deposit information storage area 22 is an area for storing the deposit information itself and can alternatively be located on the Resource Center 6. An unsealing conditions area 23 is an area for storing an electronic key used by the depositor to unseal the deposited information to read or rewrite it, and also for storing in advance the conditions for unsealing the deposit information after the depositor has died or has become unable to express his/her intentions. When the member reads or rewrites the already deposited information, the electronic information depositing part 20, in combination with the unsealing part 30 unseals the contents of the deposit information storage area 22 to transmit to the depositor's terminal 10. When the member has rewritten the deposit information, the rewritten deposit information is stored in the storage area 22 and the deposit information before writing is saved as well.

The unsealing part 30 performs necessary processing for unsealing the deposit information that is managed and kept in custody only when the member wants to rewrite the information using a predetermined electronic key 31, or when the member has died or become unable to express his/her intentions.

The predetermined electronic key 31 is used to unseal the contents of the aforementioned deposit information storage area. As electronic key 31 to unseal the deposit information an ID information or password information is used. A first confirming means 32 may check authentication information, or whether the electronic key for unsealing is genuine. A second confirming means 32 may confirm that the depositor died or has become unable to express his/her intentions due to an illness. In such a case, the existence of a genuine death notice issued by an official agency or a death certificate issued by a doctor has to be confirmed. After confirmation, the deposit information is unsealed using the electronic key. When the deposit information is unsealed based on the confirmation means 32, 33, the unsealed deposit information is sent to the recipient-specific delivery part 40 and to the memorial generating part 50 described later. Alternatively, it may be possible that a member forgets the existence of the online community or is not able to inform someone about the existence of a virtual grave. In such a case, when the death of member cannot be confirmed, it may be feasible to hypothesize maximal life duration of a person and pronounce the member's death after this period of time.

The recipient-specific delivery part 40 discloses the deposit information which was unsealed after it has been confirmed that the member has become unable to express his/her intentions, and selects the recipients, selects the contents of disclosure, and discloses the deposit information by the desired disclosure means at the desired time.

A recipient selecting means 41 specifies persons to whom the information shall be disclosed (including disclosure to the general public) by reading the names of designated persons, from among the contents of the deposit information storage area 22. A contents selecting means 42 reads the contents to be disclosed in the contents of the deposit information storage area 22 and determines the extent of contents that is to be disclosed to specified recipients. A disclosure selecting means 43 determines by what means the deposit information is to be disclosed to the selected recipients: by mail, by courier service or by an electronic medium, based on the contents of the deposit information storage area 22. The time of disclosure to the selected recipients, at the same hour or on the same day, for example, is controlled as well.

The memorial generating part 50 displays part of the unsealed deposit information and generates a virtual grave that can be accessed by the

Community Website 1. After unsealing of the deposit information a contents selecting means 51 reads the contents to be displayed on the virtual grave of the deposit information storage area 22 and determines the extent of contents that is to be displayed on the virtual grave. The member can specify in advance, which information shall be displayed on the virtual grave comprising at least one of the following information:
a notice of the member's death,
a gratitude of those who extended assistance,
reflection, repentance, confession of the member's life,
publications of the member's posthumous works,
pictures and videos of the member's life,
a plurality of member information comprising personal information, and
a guestbook capable of being written to and read by the plurality of members.

A display selecting means 52 determines how the desired information is displayed on the virtual grave. For example, information about the layout can be defined in advance. A part of the content to be displayed could be visible only to friends of the deceased member within the online community and another part could be visible to the general public or only to specified persons. In another specific embodiment, the virtual graves of all members can be displayed on a map, so that every person can search for former friends, family or other people he/she may have known. In a further alternative embodiment, the real grave can be shown, via a satellite picture, for example, so that family members who do not live in close proximity to the grave have the possibility to take care of the grave by ordering flowers.

As described above, the system for providing and managing an online community containing a will information management and disclosure system according to the present invention allows information, such as will information and information about a person's life as pictures and videos, to be deposited without exposure to third parties by keeping in custody deposit information within an online community allowing interaction between members of this online community, which are connected via friendship networks. After a member's death a process is started and the former member becomes a member of a “community of dead”. The deposit information can then be unsealed under predetermined unsealing conditions, disclosed to predetermined recipients and additionally displayed on a virtual grave, which is accessible via the Community Website of the online community.

The present invention can implement the aforementioned system for providing and managing an online community using a computer operating program as described above, and the program can be stored in any of various program storage media suitable for storing it.

I claim:

1. A system for providing and managing an online community, comprising:
a Community Website hosted on at least one Hosting Server, the at least one Hosting Server maintained by a Hosting Entity and communicatively coupled to a network;
a Resource Center accessible to a plurality of members via the Community Website, the Resource Center having a plurality of content wherein at least some of the plurality of content is generated by at least one of the plurality of members; and
a Content Management System having the ability to manage content on the Community Website;
wherein a friendship tool allowing the plurality of members, after creating an account with their personal information, to establish at least one virtual friendship with others of the plurality of members via “friend request” and to add them to their virtual friendship network, is accessible to the plurality of members via the Community Website;
wherein the Content Management System contains a will information management and disclosure system for keeping in custody deposit information deposited by a member and unsealing the deposit information under predetermined unsealing conditions, the deposit information including will information that is unsealed in accordance with unsealing conditions registered in advance by the member and/or when the member has become unable to express his/her intentions, and disclosed to a predetermined recipient; and
wherein the member enters as electronic information the deposit information prepared by the member in a rewritable manner via a depositor's terminal.

2. A system for providing and managing an online community as in claim 1 wherein the will information management and disclosure system comprises:
an electronic information depositing part to keep in custody the entered electronic information in accordance with predetermined depositing conditions, the electronic information depositing part including a memory having an unsealing conditions setting and storing area for setting and storing conditions for unsealing the deposit information;
an unsealing part to unseal the deposit information using a predetermined unsealing electronic key, having a first confirming means for confirming the occurrence of the unsealing conditions, and a second confirming means for confirming that the member has become unable to express his/her intentions;
a recipient-specific delivery part to deliver the deposit information using predetermined means to a recipient who is designated in advance by the member and satisfies predetermined conditions; and
a memorial generating part to display a part of the deposit information to the plurality of members;
wherein communications between the will information management and disclosure system and the depositor's terminal, and the processing of information prior to unsealing by the will information management and disclosure system are carried out by enciphered electronic information,
wherein the unsealing part unseals the deposit information in a case that at least one of the first confirming means and second confirming means confirms the occurrence of the unsealing conditions, and
wherein the memorial generating part generates a virtual grave after unsealing of the deposit information, the virtual grave being accessible via the Community Website.

3. A system for providing and managing an online community as in claim 2, wherein the depositor's terminal comprises authentication means for identifying and authenticating the member.

4. A system for providing and managing an online community as in claim 2, wherein the virtual grave consists of at least one of the following information:
a notice of the member's death,
a gratitude of those who extended assistance,
reflection, repentance, confession of the member's life,
publications of the member's posthumous works,
a plurality of member information comprising personal information, and
a guestbook capable of being written to and read by the plurality of members.

5. A system for providing and managing an online community as in claim 2, wherein the deposited electronic information comprises any of character, image or voice, or multimedia information of any combination of character, image and voice media.

6. A system for providing and managing an online community as in claim 2, wherein the deposit information comprises an authenticating expression for identifying the genuineness of the deposit information as prepared by the depositor, wherein the authenticating expression comprises at least one of image information on an identification certificate of the member, electronic seal information corresponding to the member's identification seal, image information on the member's autograph.

7. A system for providing and managing an online community as in claim 2, wherein the electronic information depositing part comprises a memory with a storage area to store the content of membership registration, the deposit information, and a record describing the process of unsealing the deposit information.

8. A system for providing and managing an online community as in claim 2, wherein the recipient-specific delivery part has the function
to select recipients to which the deposit information is disclosed in accordance with designation by the member,
to select the mode of delivery to the recipients by judging the environment of the recipients, and
to select disclosure means to the recipients.

9. A method of providing and managing an online community for keeping in custody deposit information deposited by a member and unsealing the deposit information under predetermined conditions, the deposit information including will information that is unsealed in accordance with unsealing conditions registered in advance by the member and/or when the member has become unable to express his/her intentions, and disclosed to a predetermined recipient, comprising the steps of:
providing a Community Website accessible to a plurality of members via network;
hosting the Community Website on at least one Hosting Server;
providing a Resource Center having a plurality of content wherein at least some of the plurality of content was generated by at least one of the plurality of members;
entering as electronic information the deposit information prepared by the member in a rewritable manner with a view to depositing via a depositor's terminal;
storing the entered electronic information in accordance with predetermined depositing conditions;
unsealing the deposited information using a predetermined unsealing electronic key in response to confirming the occurrence of the predetermined unsealing conditions, or in response to the member becoming unable to express his/her intentions;
delivering the deposit information for disclosure using predetermined means to a recipient designated in advance by the member and satisfying predetermined conditions; and
generating a virtual grave to display at least one part of the deposit information.

10. A program storage medium for storing programs for realizing a system for providing and managing an online community for keeping in custody deposit information deposited by a member and unsealing the deposit information under predetermined conditions, the deposit information including will information that is unsealed in accordance with unsealing conditions registered in advance by the member and/or when the member has become unable to express his/her intentions, and disclosed to a predetermined recipient, comprising the steps of:
providing a Community Website accessible to a plurality of members via network;
hosting the Community Website on at least one Hosting Server;
providing a Resource Center having a plurality of content wherein at least some of the plurality of content was generated by at least one of the plurality of members;
entering as electronic information the deposit information prepared by the member in a rewritable manner with a view to depositing via a depositor's terminal;
storing the entered electronic information in accordance with predetermined depositing conditions;
unsealing the deposited information using a predetermined unsealing electronic key in response to confirming the occurrence of the
predetermined unsealing conditions, or in response to the member becoming unable to express his/her intentions;
delivering the deposit information for disclosure using predetermined means to a recipient designated in advance by the member and satisfying predetermined conditions; and
generating a virtual grave to display at least one part of the deposit information.
